(19) United States
(12) Patent Application Publication
(10) Pub. No.: US 2010/0161359 A1
(43) Pub. Date: Jun. 24, 2010

(54) Risk Management for Cable Protection Via Dynamic Buffering

(75) Inventor: Michael Asher, Green Cove Springs, FL (US)

Correspondence Address: AT&T Legal Department - Moazzam;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/339,006

(22) Filed: Dec. 18, 2008

(51) Int. Cl. G06Q 10/00; G01C 21/00; G06N 5/02; G06Q 50/00

(52) U.S. Cl. 705/7; 701/300; 706/52

(57) ABSTRACT

Devices, systems and methods are disclosed which relate to optimizing a minimum cost function associated with buried asset lines by using a GIS application to generate a “dynamic buffer” around each asset line based on a risk management algorithm. A risk management algorithm, by which a GIS application can generate a “dynamic buffer”, is employed to minimize asset line damage risk and operating costs by balancing potential costs from damage against the fixed labor costs of manually screened and located tickets. Embodiments of the invention utilize the geography of the situation as well as factors for the asset itself.

### BACKGROUND OF THE INVENTION

1. Field of the Invention

The present invention relates to optimizing a minimum cost function associated with buried asset lines. More specifically, the present invention relates to optimizing a minimum cost function associated with buried asset lines by using a GIS application to generate a “dynamic buffer” around each asset line.

2. Background of the Invention

The protection of buried asset lines, such as fiber optic cables, telephone lines, power lines, water pipes, gas pipes, etc., from damage is of paramount concern to utility companies. The primary cause of damage is construction activities, unrelated to the asset line's excavation, for new building construction, boring, maintenance, installation activities by contractors for other utilities, etc. The National “Call Before You Dig” program is the first step in the protection process. This system results in a national company, ONE CALL, receiving several million “dig tickets” per year, each indicating a potentially damaging dig activity which may be near an asset line. Due to this immense ticket volume, most companies will screen at least a portion of these tickets automatically. Ticket data is used to determine a longitude/latitude location for the dig activity, and this location is matched against existing asset lines held within a GIS (geographic information system) application.

Generally, a company will receive a dig ticket and review that activity to see if it endangers an asset line. The company tries to determine how close the dig is to an asset line. However, there are literally hundreds of sources of error or inaccuracy in this process. There may be some inaccuracy concerning the asset line's location as well as a lot of inaccuracy in where the dig actually is.

For instance, a contractor can give the location of the activity as a street address. When looking that location up in a database, the location given is likely the location of a mailbox. The contractor is probably not digging on top of that mailbox, but is providing the closest address to where this dig is actually occurring.

Unfortunately, this is an inherently unreliable process. Street address data can be missing or imprecise, cable assets may be located slightly incorrectly within the GIS application, or the contractor or ONE CALL operator may have placed incorrect data on the ticket itself. Even in the best case, there is inherent error as the closest postal “street address” to a dig activity may be meters (or in a rural area, miles) from the actual excavation location. This unreliability results in risk of cable damage. A ticket may be improperly judged as “not involved” (i.e., not endangering cable assets). The contractor is thus given an “all clear” notice from the cable owner, begins to excavate, and cuts a cable, causing damage and revenue losses potentially in the millions of dollars.

The standard model for asset line protection therefore involves locating a ticket not against an asset line directly, but against a fixed-size “buffer”, defined as the set of points within a set distance from the asset line. A buffer 200 meters wide, for instance, will “involve” not only digs directly atop asset lines, but those 100 meters on each side as well. This reduces risk, but increases the volume of tickets which must be manually inspected by field personnel. As each ticket (even if uninvolved) has a labor cost associated with it, this results in a standard tradeoff scenario.

The larger the buffer is, the more likely a ticket anywhere in that region will require a follow-up. Also, with a larger buffer it is less likely there will be a false negative. A false negative is a ticket determined, due to some inaccuracy, to not be near an asset line when an asset line is in danger. However, with a larger buffer more false positives occur. A false positive is a ticket determined to be near an asset when it is not. What companies try to do in all cases is balance the cost of false positives to false negatives. In doing so a company finds an amount of false positives acceptable in return for a minimum amount of false negatives. Increasing the buffer size increases the number of false positives, but decreased the likelihood of a false negative.

The values of asset lines vary greatly. A more valuable asset line is more costly when it is damaged. Thus, a company is likely willing to accept more false positives to avoid damage to that asset line. Many companies simply use the same fixed buffer-width for every line. Asset lines do not have a constant value either. For instance, a fiber optic line may carry a small amount of data when it is first installed, making it of relatively little value. As the area progresses, that same fiber optic line may carry a much larger amount of data to and from residents, companies, governments, etc., making it of greater value.

What is needed is a way to calculate an optimal buffer-width unique to each asset line and update the asset line's buffer-width in real time.

### SUMMARY OF THE INVENTION

The present invention optimizes a minimum cost function associated with buried asset lines by using a GIS application to generate a “dynamic buffer” around each asset line based on a risk management algorithm. A risk management algorithm, by which a GIS application can generate a “dynamic buffer”, is employed to minimize asset line damage risk and operating costs by balancing potential costs from damage against the fixed labor costs of manually screened and located tickets. Embodiments of the invention utilize the geography of the situation as well as factors for the asset itself.

In one exemplary embodiment, the present invention is a method of minimizing the cost risk of an asset line carrying a utility, comprising assessing a first factor identifying an ability to automatically re-route the utility in the event of a loss of the asset line, assessing a second factor measuring the total value of the utility carried by the asset line, inputting the first factor and the second factor into a risk management algorithm, solving the risk management algorithm for a dynamic buffer width, and assigning the dynamic buffer width to the asset line. A dig location is evaluated by its position with respect to the dynamic buffer width.

In another exemplary embodiment, the present invention is a system for minimizing the cost risk of a buried asset line carrying a utility, comprising a server, a GIS application on the server, a risk management logic on the server, and a database having a plurality of restorability factors and a plurality of revenue factors in communication with the server. The server responds to a dig location query with an evaluation of a dig location with respect to a dynamic buffer width calculated using the risk management logic.

In yet another exemplary embodiment, the present invention is a software program, stored on a computer readable medium, for minimizing the cost risk of an asset line carrying a utility, comprising a first code segment for assessing a first factor identifying an ability of the network to automatically re-route communication in the event of a loss of the asset line, a second code segment for assessing a second factor measuring the total value of utility carried by the asset line, a third code segment for inputting the first factor and the second factor into a risk management algorithm, a fourth code segment for solving the risk management algorithm for a dynamic buffer width, and a fifth code segment for assigning the dynamic buffer width to the asset line. A dig location is evaluated by its position with respect to the dynamic buffer width.

### BRIEF DESCRIPTION OF THE DRAWINGS

FIG. 1 shows a method of creating a dynamic buffer and responding to dig tickets, according to an exemplary embodiment of the present invention.

FIG. 2 shows a dynamic buffering system, according to an exemplary embodiment of the present invention.

FIG. 3 shows a universal asset line location system, according to an exemplary embodiment of the present invention.

FIG. 4A shows an example of restorability, according to an exemplary embodiment of the present invention.

FIG. 4B shows an example of restorability after a break in an asset line, according to an exemplary embodiment of the present invention.

FIG. 5 shows dynamic buffers on a GIS application, according to an exemplary embodiment of the present invention.

### DETAILED DESCRIPTION OF THE INVENTION

The present invention optimizes a minimum cost function associated with buried asset lines by using a GIS application to generate a “dynamic buffer” around each asset line based on a risk management algorithm. A risk management algorithm, by which a GIS application can generate a “dynamic buffer”, is employed to minimize asset line damage risk and operating costs by balancing potential costs from damage against the fixed labor costs of manually screened and located tickets. Embodiments of the invention utilize the geography of the situation as well as factors for the asset itself.

“Asset line,” as used herein and throughout this disclosure, refers to a buried medium used in connection with a service. Examples of an asset line include an electrical line, water pipe, gas pipe, telephone cable, coaxial cable, fiber optic line, etc.

The risk management algorithm depends upon a GIS “auto-screening” application having access to certain cable logical parameters. The first of these is the cable restorability, a factor identifying the ability to automatically route around the loss of the asset line. For instance, with a cable that is 100% restorable, if that cable is cut there is zero loss of revenue. The only damages from that cut are the physical damages to repair the cable. There is no revenue loss. There can be cables that are 100% restorable, 0% restorable, or anything in between. The second logical parameter is revenue, a measure of the total value of the asset line. Generally the revenue is expressed in terms of the time period for the expected restoration. The time period for expected restoration is the expected amount of time it would take to repair that cable. For example, if the average time to repair a cable is 48 hours, the revenue function is 48 hours of revenue because that is what is lost if that cable was cut.

These two factors are used to compute an expectation value for the loss incurred by damage to the cable. This expectation value is expressed as a function of the buffer width for the given cable. A wider buffer results in less false negatives, which are tickets improperly adjudged as not involved. A second function is also computed, expressing the cost of false positives, which are tickets improperly adjudged as involved. An expectation value for the loss from a damaged asset line is computed as well as a cost of a false positive. The false positive cost is a much smaller cost on a per item basis. That is, the cost of responding to a ticket even if there is no activity occurring near an asset line. This may involve sending a technician simply to mark the area, or having a technician on site to make phone calls, sending letters, monitor, etc. Generally, there is a labor cost associated with a false positive.

False positives may be calculated in a few different ways. Typically, the system uses the width as a parameter to compute the total area covered by the buffer. The system expresses the cost of false positives as a function of the total area of the asset line and assumes that as that width increases the number of false positive climbs. Doubling the area generally gives double the false positives because the ratio of that area is also double. Other ways of calculating false positives are also possible, based upon the assumptions made.

Both the false positive and false negative expressions are a function of the cable buffer width. The expression can be minimized by finding the root(s) of the first derivative with respect to width:

$$\frac{d}{d w} [ L ( w ) - M ( w ) ] = 0$$

where L(w) is the loss expectation function, and M(w) the maintenance cost function. The loss expectation function is the product of the restorability factor, the revenue factor, and the likelihood of damage. The likelihood that damage will occur is expressed as a function of the buffer-width. A larger buffer results in less likelihood of damage. If desired, the loss expectation function can be modified by a “public relations” factor, which assigns a virtual cost to every cable cut, on the rationale that such events reduce customer confidence in the network. This modification does not change the overall functioning of the risk management algorithm. The maintenance cost function is the product of the fixed cost of a false positive and the number of false positives that will occur. The number of false positives is expressed as a function of the buffer-width. A larger buffer results in a larger number of false positives. Once the two expectation values are expressed as a function of the buffer width, setting the derivative equal to zero and solving for the width gives an optimum buffer-width for that asset line.

This root can be found by either standard analytical or numerical means, and yields the optimum buffer-width for any given asset line. A wider buffer increases maintenance costs faster than it reduces expected losses, and, conversely, a narrower buffer increases loss potential faster than it reduces maintenance costs.

For example, in an urban area where a cable is 100% restorable it may have a very narrow buffer because the cost associated with damage to that cable is very low. If that cable is cut there is the physical cost of repair but no revenue loss. If two cables are near each other but one cable carries ten times the call volume as the other cable, then the buffer for the cable carrying more call volume is much larger.

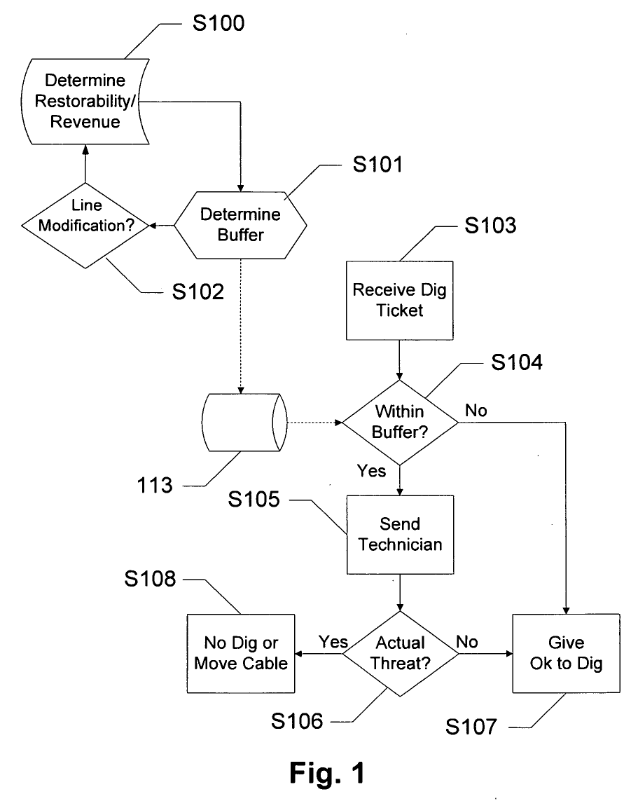

FIG. 1 shows a method of creating a dynamic buffer and responding to dig tickets, according to an exemplary embodiment of the present invention. In this embodiment, a utility company has installed asset lines into the ground at a location. The location of these asset lines is plotted into a Geographical information system (GIS). The GIS shows the location of the asset lines on a map or grid. With the location plotted, the restorability and revenue of each of the asset lines is determined by logic within a server or computer in the system S100. With the restorability and revenue determined, the logic determines a buffer width and plots the buffer on the GIS S101. If the asset line is modified, such as with an increased volume, decreased volume, disablement of the asset line, etc., then new restorability and revenue factors are calculated for it and any other affected asset lines S102. A modified buffer is determined with the new restorability and revenue factors.

When the utility company receives a dig ticket from a third party, the utility company enters the location of the dig ticket into the system S103. The system queries and determines whether the dig ticket is within a buffer from any of the asset lines S104. If the dig ticket is not within a buffer, the system notifies the utility company that it is alright to dig in this area S107. The utility company relays this information to the third party, or, alternatively, the system can directly communicate with the third party. If the dig ticket is within the buffer of one of the asset lines, the utility company sends a technician to the field to determine the exact location of the dig with respect to the asset line S105. The technician determines whether it is safe to dig at that location or whether there is an asset line present S106. If an asset line is present, the asset line is moved, re-routed, etc., or the dig is not allowed S108. If the technician determines there is not an asset line within the dig area, the technician allows the dig S107.

Generally, once a dig ticket is received, within a few minutes the dig ticket is transferred from one call center to all relevant utilities to be processed. The dig ticket is screened and at least allocated to a technician within a few minutes of that call. Once the dig ticket is judged to be involved or not, that ticket is dead and not looked at again. However, the ticket may be called in for work a week in advance, and changes may occur to the dynamic buffer in that time. In exemplary embodiments of the present invention, the process can go back and look at previously screen tickets to ensure that decision was still correct.

In other exemplary embodiments of the present invention, an archival flow occurs due to automated processes. These processes may run daily, hourly, monthly, etc. based upon the wants and needs of the utility company or companies. The process uses asset restorability and revenue values to re-compute an entire buffer layer. When tickets are processed on an on-demand basis, they are not compared directly to the buried assets but to those dynamic buffers.

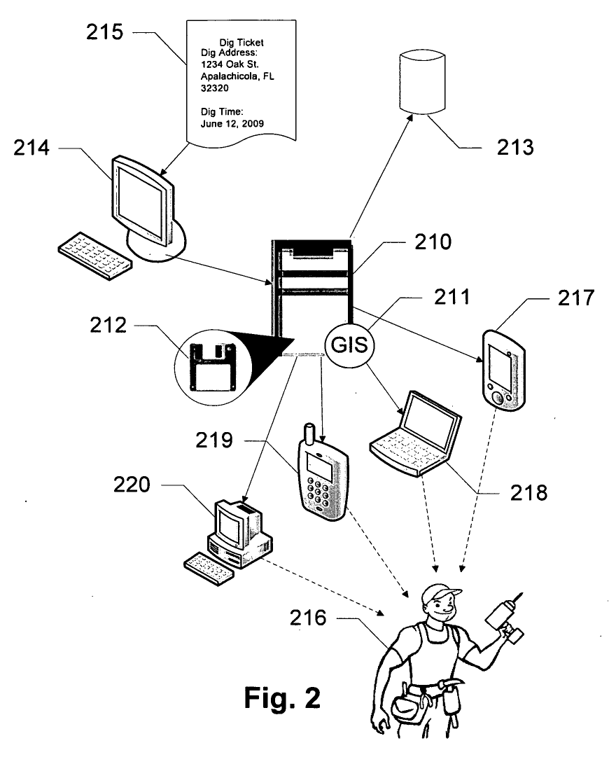

FIG. 2 shows a dynamic buffering system, according to an exemplary embodiment of the present invention. In this embodiment, the system comprises a computer 214 and other entry devices 217, 218, 219, and 220, a server 210, a risk management logic 212 onboard server 210, a GIS application 211 onboard server 210, and a database 213. Computer 214 allows a user to enter in the locations of asset lines into GIS application 211. Properties of each of the asset lines are entered in additionally. For instance, these properties include, but are not limited to, a bandwidth available, the number of devices accessing the bandwidth, the amount of revenue due to the asset line, etc. Risk management logic 212 on server 210 uses these properties to determine the restorability and revenue from each asset line. The restorability is a factor identifying the ability to automatically route around the loss of the asset line. The revenue is a measure of the total value of the asset line. Both the restorability and revenue are dynamic, and may frequently change. New asset lines placed, asset lines down, new customers, etc. create changes in both of these values. Therefore, the system frequently recalculates these values. With the restorability and revenue determined, logic 212 onboard server 210 creates a dynamic buffer for each asset line. Because the restorability and revenue frequently change, the dynamic buffer changes with them. The dynamic buffer is changed on GIS application 211 as these changes occur. Database 213 stores the constantly changing restorability and revenue factors for each asset line.

A cable may be 100% restorable because it is sharing restorability with a neighboring cable a mile away. Suppose the neighboring cable gets cut as a result of damage or just an equipment failure. Now the first cable, which was 100% restorable, is 0% restorable. With a real time change in the restorability, the process in real time widens the buffer around the remaining cable accordingly. The integrity of the cable, which was not critical before the cut of the neighboring cable, is suddenly much more critical because of a physical change in the network. In real time, the system devotes more resources towards protecting that cable.

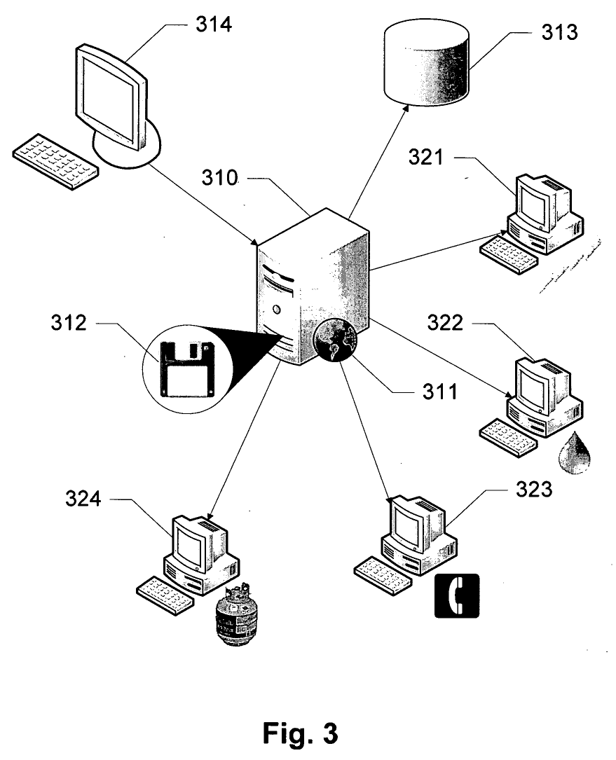

FIG. 3 shows a universal asset line location system, according to an exemplary embodiment of the present invention. In this embodiment, the system comprises a central server 310, a central database 313, a logic 312 onboard central server 310, a GIS application 311 onboard central server 310, third party terminals 321, 322, 323, and 324, and a local terminal 314. Third party asset owners enter the locations of their assets into GIS applications and upload the locations to GIS application onboard central server using third party terminals 321, 322, 323, and 324. For instance, an electric company adds a new asset line. The electric company adds the location of this asset line to their GIS application and sends this GIS layer to central server 310 via third party terminal 321. Third party asset owners also upload each asset line's restorability and revenue to central server 310, which stores these values on central database 313. Logic 312 onboard central server 310 uses the restorability and revenue from each asset line to create a dynamic buffer in GIS application 311 around each of the asset lines. The dynamic buffer appears as a layer on GIS application 311. Local terminal 314 allows a user to enter data, access GIS application 311, etc. When a dig ticket is called in, the location is entered into local terminal 314 to determine if the location is within an asset line's buffer. Any affected utility is notified of a dig near an asset line's buffer.

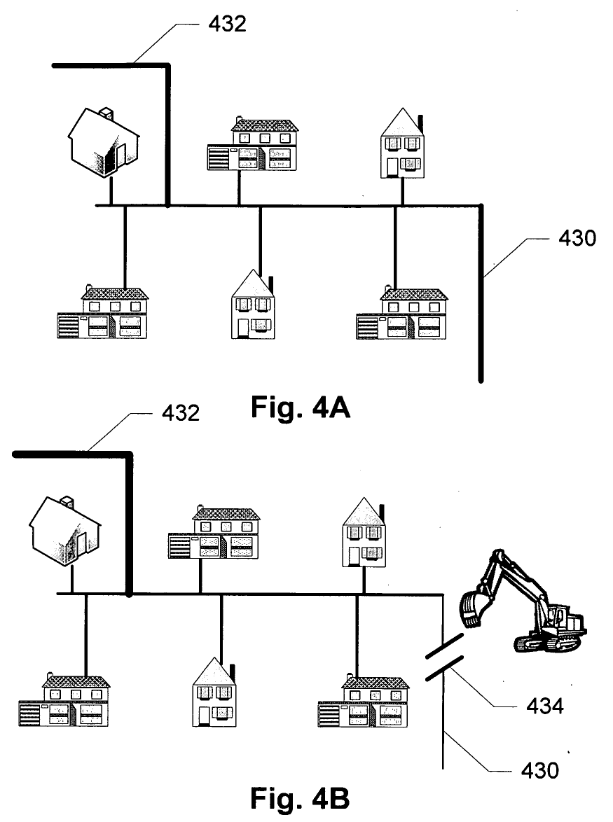

FIGS. 4A and 4B show an example of restorability, according to an exemplary embodiment of the present invention. In FIG. 4A, an asset line 430 has a capacity of one-hundred units, and is working at 50% capacity. A second asset line 432 has a capacity of one-hundred units and is working at 75% capacity. Because only twenty-five of the fifty units carried by asset line 430 may be transferred after a break to second asset line 432, asset line 430 is 50% restorable. Second asset line 432 can transfer fifty of its seventy-five units to asset line 430 in case of a break. Therefore, second asset line 432 is 66% restorable.

In FIG. 4B, asset line 430 has suffered a break 434 while second asset line 432 remains and can serve the same area. When asset line 430 is broken, part of the capacity is shifted to second asset line 432 before second asset line 432 reaches capacity. Second asset line 432 takes on twenty-five units from asset line 430 before reaching capacity. The remaining twenty-five units cannot be transferred to second asset line 432 and has no other means of transfer. Now that second asset line 432 has no neighboring asset line to transfer its capacity, second asset line 432 is 0% restorable.

An asset line that is only 50% restorable loses revenue in the event of a break because the utility can not be provided to all of the customers until the asset line is fixed. The restorability of 50% is multiplied by the revenue of that asset line to determine the potential loss of revenue due to a break.

After generating the optimum values for each cable in the physical network, a new “buffer layer” is generated in the GIS application, resulting in a dynamic buffer. This dynamic buffer is one having a differing width for each asset line. The process is typically run on a fixed basis, such as nightly, weekly, etc., so that changes to the logical network can be reflected in the buffer layer. The overall result is a substantial cost savings for cable protection activities.

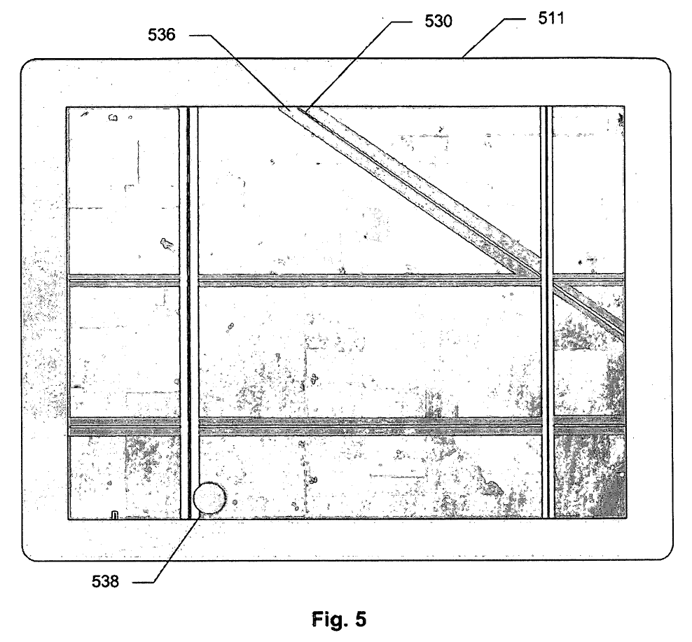

FIG. 5 shows dynamic buffers on a GIS application 511, according to an exemplary embodiment of the present invention. In this embodiment, asset lines have been located on a layer of a map within GIS application 511. Surrounding the location of an asset line 530 is a dynamic buffer 536. Dynamic buffer 536 is created on a separate layer of GIS application 511 which is overlaid upon the asset line layer. Logic on a server uses the restorability and revenue of asset line 530 to create dynamic buffer 536. A dig location 538 is entered into the server and located on GIS application 511. As shown, dig location 538 is encroaching upon dynamic buffer 536 surrounding asset line 530. Because of this encroachment, a technician is sent to dig location 538 to determine the specific position of asset line 530 and ultimately whether asset line 530 is at risk.

In other embodiments of the GIS application, the dynamic buffer is created on the same layer as the asset lines. The view can be adjusted, such that a user can zoom in or zoom out, pan, tilt, etc. to get a more precise view of the asset line and dig locations. The GIS application periodically updates the dynamic buffers. The refresh rate of the updates may be adjusted from real-time to any program or user determined period. The map layer may be a computer generated map, a satellite image, etc. The asset line and buffer width layer can include all utilities on one layer or separate individual utilities into their own layers.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of minimizing the cost risk of an asset line carrying a utility, comprising:
assessing a first factor identifying an ability to automatically re-route the utility in the event of a loss of the asset line;
assessing a second factor measuring the total value of the utility carried by the asset line;
inputting the first factor and the second factor into a risk management algorithm;
solving the risk management algorithm for a dynamic buffer width; and
assigning the dynamic buffer width to the asset line;
wherein a dig location is evaluated by its position with respect to the dynamic buffer width.

2. The method in claim 1, further comprising reassessing the first and second factors in real time.

3. The method in claim 1, wherein the assigning further comprises overlaying the dynamic buffer width on a map layer of a GIS application.

4. The method in claim 3, further comprising overlaying the dig location on the map layer of the GIS application.

5. The method in claim 1, further comprising sending a technician to a dig location evaluated to be within the dynamic buffer width of the asset line.

6. A system for minimizing the cost risk of a buried asset line carrying a utility, comprising:
a server;
a GIS application on the server;
a risk management logic on the server; and
a database having a plurality of restorability factors and a plurality of revenue factors in communication with the server;
wherein the server responds to a dig location query with an evaluation of a dig location with respect to a dynamic buffer width calculated using the risk management logic.

7. The system in claim 6, wherein the plurality of restorability factors and plurality of revenue factors are updated periodically.

8. The system in claim 7, wherein the GIS application is refreshed when the plurality of restorability factors and plurality of revenue factors are updated.

9. The system in claim 6, wherein the server is in communication with a plurality of utility companies.

10. The system in claim 6, wherein the GIS application has a dynamic buffer layer overlaying a map layer.

11. The system in claim 6, wherein the GIS application dedicates an individual dynamic buffer layer to each utility.

12. A software program, stored on a computer readable medium, for minimizing the cost risk of an asset line carrying a utility, comprising:
a first code segment for assessing a first factor identifying an ability of the network to automatically re-route communication in the event of a loss of the asset line;
a second code segment for assessing a second factor measuring the total value of the utility carried by the asset line;
a third code segment for inputting the first factor and the second factor into a risk management algorithm;
a fourth code segment for solving the risk management algorithm for a dynamic buffer width; and
a fifth code segment for assigning the dynamic buffer width to the asset line;
wherein a dig location is evaluated by its position with respect to the dynamic buffer width.

13. The software program in claim 12, further comprising a sixth code segment for reassessing the first and second factors in real time.

14. The method in claim 12, wherein the fifth code segment further comprises overlaying the dynamic buffer width on a map layer of a GIS application.

15. The method in claim 14, further comprising a seventh code segment for overlaying the dig location on the map layer of the GIS application.
